(19) United States
(12) Patent Application Publication
(10) Pub. No.: US 2025/0205925 A1
(43) Pub. Date: Jun. 26, 2025

(54) ENGINEERED STRUCTURES FABRICATED FROM SCRAP MATERIALS, AND SYSTEMS AND METHODS FOR FABRICATION AND USE THEREOF

(71) Applicants: UNIVERSITY OF MARYLAND, COLLEGE PARK, College Park, MD (US); INVENTWOOD INC., College Park, MD (US)

(72) Inventors: Liangbing HU, Woodbridge, CT (US); Yu LIU, Berwyn Heights, MD (US); Yue GAO, Berwyn Heights, MD (US); Jiaqi DAI, Washington, DC (US); Allan BRADSHAW, Lake Tapps, WA (US)

(21) Appl. No.: 18/999,162

(22) Filed: Dec. 23, 2024

Related U.S. Application Data
(60) Provisional application No. 63/614,577, filed on Dec. 23, 2023.

(51) Int. Cl. B27N 3/08; B27N 1/00; B27N 7/00; B32B 21/13

(52) U.S. Cl. CPC B27N 3/08; B27N 1/00; B27N 7/00; B32B 21/13; B32B 2250/03; B32B 2250/40; B32B 2307/72

(57) ABSTRACT

Scrap plant or plant-based materials are processed to form an engineered structure, or a portion thereof. An assembly of individual strands of scrap material can be provided, with the fiber directions of the strands within the assembly being substantially aligned. The assembly of scrap material strands can be subjected to one or more chemical treatments that modify a property of the lignin in and/or partially remove the lignin from the individual scrap material strands. The alignment of the fiber directions can be maintained during the chemical treatment(s). The chemically-treated assembly can be compressed to form a densified piece of scrap material, for example, having enhanced mechanical properties.

### CROSS-REFERENCE TO RELATED APPLICATIONS

The present application claims the benefit of and priority under 35 U.S.C. § 119 (e) to and is a non-provisional of U.S. Provisional Application No. 63/614,577, filed Dec. 23, 2023, entitled “Densified Boards from Scrap Plant-Based Materials, and Systems and Methods for Fabrication and Use Thereof,” which is hereby incorporated by reference herein in its entirety.

### STATEMENT REGARDING FEDERALLY SPONSORED RESEARCH

This invention was made with government support under DE-AR0001392 awarded by the U.S. Department of Energy. The government has certain rights in the invention.

### FIELD

The present disclosure relates generally to engineered structures, and more particularly, to engineered structures fabricated from scrap plant or plant-based materials, as well as systems and methods for fabrication and use of such engineered structures.

### BACKGROUND

Scrap plant or plant-based materials, such as scrap wood or used cardboard, are typically considered unusable surplus or waste. Various approaches have been proposed to make efficient use of scrap materials, for example, by incorporating scrap wood into engineered products such as oriented strand board (OSB) or parallel strand lumber (PSL). OSB is composed of wood strands or flakes bonded together with adhesives and then compressed into sheets. These strands are often arranged in layers, with each layer perpendicular to the one adjacent to it. PSL is created from large wood veneer strips or strands that are bonded together using adhesives and high-pressure compression, typically aligned parallel and forming long, rectangular shapes. Despite their structural advantages and efficiency in utilizing scrap wood, both OSB and PSL often have mechanical properties less than that of natural wood. Other approaches that utilize scrap wood to produce engineered structures rely on delignification, partial dissolution, and subsequent regeneration in order to expose cellulose fibrils originally found within the cell walls of the wood. These fibrils create robust hydrogen bonding networks at interphases, resulting in a “repaired” wood-based structure with enhanced mechanical strength. However, such approaches tend to be time-consuming, energy intensive, and/or produce chemical waste. Embodiments of the disclosed subject matter may address one or more of the above-noted problems and disadvantages, among other things.

### SUMMARY

Embodiments of the disclosed subject matter provide engineered structures fabricated from scrap plant material (e.g., scrap wood) or scrap plant-based material (e.g., used cardboard), as well as systems and methods for fabrication and use of such engineered structures. In some embodiments, the scrap material can be cut into individual strands and arranged in an assembly (e.g., stack) with fiber directions thereof at least partially aligned. In some embodiments, the assembly may be subjected to a lignin compromising treatment (e.g., to partially remove lignin and/or modify lignin) or otherwise softened (e.g., via soaking in water) prior to compressing (e.g., by pressing in a direction perpendicular to, or at least crossing, the fiber directions) to form a densified piece. In some embodiments, the alignment of fiber directions can be substantially maintained during the processing, for example, from the lignin compromising treatment through the compressing. In some embodiments, the resulting densified piece can have anisotropic and/or enhanced mechanical properties (e.g., a tensile strength, bending strength, compressive strength, etc.). Embodiments of the disclosed subject matter can thus transform scrap material with low strength, quality, and/or utility (e.g., which would otherwise be wasted, discarded, or relegated to low-strength applications) into high-strength engineered structures via a cost-effective, reduced waste process.

In one or more embodiments, a system for processing scrap material can comprise a cutting stage, one or more holders, an alignment stage, a lignin compromising stage, and a densification stage. The cutting stage can comprise one or more blades and can be constructed to cut an input feedstock of scrap material (e.g., scrap plant or plant-based material) into individual strands. Each strand can have a fiber direction along which cellulose fibers therein are substantially aligned. The alignment stage can be constructed to dispose the strands of scrap material from the cutting stage within at least one of the one or more holders such that the fiber directions of the disposed strands are substantially aligned, thereby forming an assembly of scrap material within the at least one holder. The lignin compromising stage can comprise one or more treatment vessels. The lignin compromising stage can be constructed to receive the at least one holder with the assembly therein and to chemically treat the assembly so as to modify a property of lignin within and/or partially remove the lignin from the strands forming the assembly. The densification stage can comprise a mechanical press. The densification stage can be constructed to receive the at least one holder with the chemically-treated assembly therein and to compress the chemically-treated assembly so as to form a densified piece of scrap material. The one or more holders can be constructed to move the assembly of scrap material between and within the alignment stage, the lignin compromising stage, and the densification stage, while substantially maintaining alignment of the fiber directions of the strands forming the assembly.

In one or more embodiments, a method for processing scrap material (e.g., scrap plant or plant-based material) can comprise providing an assembly of individual strands of scrap material. Each strand can have a fiber direction along which cellulose fibers therein are substantially aligned. The fiber directions of the individual strands within the assembly can be substantially aligned. The method can further comprise subjecting the assembly of individual strands of scrap material to one or more chemical treatments so as to modify a property of lignin within and/or partially remove the lignin from strands of scrap material forming the assembly, while maintaining alignment of the fiber directions of the strands forming the assembly. The method can also comprise compressing the chemically-treated assembly so as to form a densified piece of scrap material.

In one or more embodiments, an engineered structure formed from scrap material (e.g., scrap plant or plant-based material) can comprise one or more laminated structures. Each laminated structure can comprise a plurality of plant or plant-based material pieces forming at least two layers. Each plant or plant-based material piece can be coupled to an adjacent plant or plant-based material piece. At least one of the plant or plant-based material pieces can have a density of at least 1 g/cm³. The plant or plant-based material pieces in at least one of the at least two layers can be formed from scrap material. The plant or plant-based material pieces in a first layer of the at least two layers can have mechanical strengths greater than those of the plant or plant-based material pieces in a second layer of the at least two layers.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

Embodiments will hereinafter be described with reference to the accompanying drawings, which have not necessarily been drawn to scale. Where applicable, some elements may be simplified or otherwise not illustrated in order to assist in the illustration and description of underlying features. Throughout the figures, like reference numerals denote like elements.

FIG. 1A is a process flow diagram for a generalized method for fabricating an engineered structure from scrap materials, according to one or more embodiments of the disclosed subject matter.

FIG. 1B is a simplified schematic diagram of an individual strand of scrap material for processing, according to one or more embodiments of the disclosed subject matter.

FIG. 1C illustrates aspects of an exemplary fabrication of an engineered structure from scrap wood pieces, according to one or more embodiments of the disclosed subject matter.

FIG. 1D illustrates aspects of an exemplary fabrication of an engineered structure from scrap cardboard, according to one or more embodiments of the disclosed subject matter.

FIG. 2 shows a simplified cross-sectional view of a laminated structure having one or more densified pieces fabricated from scrap material, according to one or more embodiments of the disclosed subject matter.

FIG. 3A illustrates aspects of a generalized system for fabricating an engineered structure from scrap materials, according to one or more embodiments of the disclosed subject matter.

FIG. 3B illustrates further details of a system for fabricating an engineered structure from scrap materials, according to one or more embodiments of the disclosed subject matter.

FIG. 3C illustrates an exemplary holder for transporting an assembly of scrap material strands between processing stages, according to one or more embodiments of the disclosed subject matter.

FIG. 3D illustrates aspects of the use of a holder during compression of the assembly of scrap material strands to form a densified piece, according to one or more embodiments of the disclosed subject matter.

FIG. 4 depicts a generalized example of a computing environment in which the disclosed technologies may be implemented.

FIG. 5A illustrates aspects of a performed experiment for fabricating a densified piece from scrap wood, according to one or more embodiments of the disclosed subject matter.

FIG. 5B shows scanning electron microscopy (SEM) images of a surface of the densified piece from the experiment of FIG. 5A.

FIG. 5C shows an SEM image of a fracture surface of the densified piece from the experiment of FIG. 5A after tensile testing.

FIG. 5D is a graph comparing measured tensile strengths for the original scrap wood, other densified products, and the densified piece from the experiment of FIG. 5A.

FIG. 6A shows an image depicting determination of fiber direction in scrap cardboard based on tear direction and an SEM image showing the underlying fiber alignment.

FIG. 6B illustrates aspects of a performed experiment for fabricating a densified piece from scrap cardboard, according to one or more embodiments of the disclosed subject matter.

FIG. 6C shows SEM images of a surface of the densified piece from the experiment of FIG. 6B.

FIG. 6D shows an SEM image of a fracture surface of the densified piece from the experiment of FIG. 6B after tensile testing.

FIG. 6E is a graph comparing measure tensile strengths for the original scrap cardboard and the densified piece from the experiment of FIG. 6B.

FIG. 7 shows a stress-strain curve a densified piece fabricated from scrap cardboard in another performed experiment.

### DETAILED DESCRIPTION

### General Considerations

For purposes of this description, certain aspects, advantages, and novel features of the disclosed subject matter are described herein. The disclosed methods and systems should not be construed as being limiting in any way. Instead, the present disclosure is directed toward all novel and nonobvious features and aspects disclosed herein, alone and in various combinations and sub-combinations with one another. The methods and systems are not limited to any specific aspect or feature or combination thereof, nor do the disclosed aspects require that any one or more specific advantages be present, or problems be solved. The technologies from any aspect or example can be combined with the technologies described in any one or more of the other aspects or examples. In view of the many possible aspects to which the principles of the disclosed technology may be applied, it should be recognized that the illustrated aspects of the disclosure are exemplary only and should not be taken as limiting the scope of the disclosed technology.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one skilled in the art.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person skilled in the art to have a more definitive construction, the numerical parameters set forth are approximations that may depend on the desired properties sought and/or limits of detection under standard test conditions/methods, as known to those skilled in the art. When directly and explicitly distinguishing aspects from discussed prior art, the numbers are not approximates unless the word “about,” “substantially,” or “approximately” is recited. Whenever “substantially,” “approximately,” “about,” or similar language is explicitly used in combination with a specific value, variations up to and including 10% of that value are intended, unless explicitly stated otherwise.

Directions and other relative references may be used to facilitate discussion of the drawings and principles herein but are not intended to be limiting. For example, certain terms may be used such as “inner,” “outer,” “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated aspects. Such terms are not, however, intended to imply absolute relationships, positions, and/or orientations. For example, with respect to an object, an “upper” part can become a “lower” part simply by turning the object over. Nevertheless, it is still the same part, and the object remains the same.

As used herein, “comprising” means “including,” and the singular forms “a” or “an” or “the” include plural references unless the context clearly dictates otherwise. The term “or” refers to a single element of stated alternative elements or a combination of two or more elements unless the context clearly indicates otherwise.

Although there are alternatives for various components, parameters, operating conditions, etc. set forth herein, that does not mean that those alternatives are necessarily equivalent and/or perform equally well. Nor does it mean that the alternatives are listed in a preferred order, unless stated otherwise. Unless stated otherwise, any of the groups defined below can be substituted or unsubstituted.

Unless explained otherwise, all technical and scientific terms used herein have the same meaning as commonly understood to one skilled in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Features of the presently disclosed subject matter will be apparent from the following detailed description and the appended claims.

### Overview of Terms

The following are provided to facilitate the description of various aspects of the disclosed subject matter and to guide those skilled in the art in the practice of the disclosed subject matter.

Plant Material: A portion (e.g., a cut piece or other portion, via mechanical means or otherwise) of any photosynthetic eukaryote of the kingdom Plantae as grown. In some embodiments, the plant material comprises wood (e.g., hardwood or softwood), bamboo (e.g., any of Bambusoideae, such as but not limited to Moso, Phyllostachys vivax, Phyllostachys viridis, Phyllostachys bambusoides, and Phyllostachys nigra), reed (e.g., any of common reed (Phragmites australis), giant reed (Arundo donax), Burma reed (Neyraudia reynaudiana), reed canary-grass (Phalaris arundinacea), reed sweet-grass (Glyceria maxima), small-reed (Calamagrostis species), paper reed (Cyperus papyrus), bur-reed (Sparganium species), reed-mace (Typha species), cape thatching reed (Elegia tectorum), and thatching reed (Thamnochortus insignis)), hemp (Cannabis sativa), palm (e.g., a species selected from the Arcales order or the Arecaceae family), or grass (e.g., a species selected from the Poales order or the Poaceae family). For example, the natural wood can be any type of hardwood (e.g., having a native lignin content in a range of 18-25 wt %) or softwood (e.g., having a native lignin content in a range of hemp (Cannabis sativa), 25-35 wt %), such as, but not limited to, basswood, oak, poplar, ash, alder, aspen, balsa wood, beech, birch, cherry, butternut, chestnut, cocobolo, elm, hickory, maple, oak, padauk, plum, walnut, willow, yellow poplar, bald cypress, cedar, cypress, Douglas fir, fir, hemlock, larch, pine, redwood, spruce, tamarack, juniper, and yew. Alternatively, in some embodiments, the plant material can be any type of fibrous plant composed of lignin and cellulose. For example, the plant material can be bagasse (e.g., formed from processed remains of sugarcane or sorghum stalks) or straw (e.g., formed from processed remains of cereal plants, such as rice, wheat, millet, or maize).

Plant-based Material: A processed material formed from and/or comprising plant material or a component thereof (e.g., cellulose), for example, paper, paperboard, cardboard, fiberboard, boxboard, chipboard, Kraft board, laminated board, solid bleached board, solid unbleached board, container board, etc. In some embodiments, the plant-based material may be an engineered structure, or a portion thereof, formed from and/or comprising a plant material, such as but not limited to CLT, glulam, LVL, OSB, PSL, and OSSB.

Engineered Structure: A structure comprising and/or formed from at least one piece of plant or plant-based material that has been compressed to have a reduced thickness (e.g., no more than 50% of its original thickness) and/or an increased density (as compared to its original density, for example, prior to processing and/or as provided), for example, at least 1.0 g/cm³ (e.g., at least 1.1 g/cm³, or at least 1.2 g/cm³, or at least 1.3 g/cm³). In some embodiments, the engineered structure comprises a laminated structure formed by plurality of pieces or layers of plant or plant-based materials (e.g., densified or otherwise) coupled together (with or without an adhesive or added filler), which engineered structure may offer improved strength and/or durability. Examples of such laminated structures include, but are not limited to, laminated timber or bamboo (e.g., cross-laminated timber (CLT), glued laminated timber (glulam), laminated veneer lumber (LVL), etc.), strand wood or bamboo boards (e.g., oriented strand board (OSB), parallel strand lumber (PSL), etc.), and/or equivalents formed from plant or plant-based materials other than wood or bamboo (e.g., oriented structural straw board (OSSB), etc.).

Moisture content: The amount of fluid, typically water, retained within the microstructure of the plant or plant-based material. In some embodiments, the moisture content (MC) can be determined by oven-dry testing, for example by calculating the change in weight achieved by oven drying (e.g., at 103° C. for 6 hours) the plant or plant-based material, using the equation: MC (%)=

$$\frac{weight before dry - weight after dry}{weight before dry} \times 100.$$

Alternatively or additionally, moisture content can be assessed using known techniques in the art, for example, an electrical moisture meter or other techniques disclosed in ASTM D4442-20 (2020) for “Standard Test Methods for Direct Moisture Content Measurement of Wood and Wood-based Materials,” published by ASTM International, which standard is incorporated herein by reference.

Lignin-compromised material: Plant or plant-based material that has been modified by one or more chemical treatments to (a) in situ modify the lignin therein or (b) partially remove the lignin originally therein (i.e., partial delignification). In some embodiments, the lignin-compromised material can substantially retain the microstructure of the starting material (e.g., formed by cellulose-based cell walls).

Partial Delignification: The removal of some (e.g., at least 5%, on a weight percent basis) but not all (e.g., less than or equal 95% on a weight percent basis) of the original lignin content (e.g., prior to processing and/or at the time of harvesting the original plant material) from the plant or plant-based material. In some embodiments, the partial delignification can be performed by subjecting the plant or plant-based material to one or more chemical treatments. In some embodiments, the lignin content after partial delignification can be, for example, in a range of 0.9-23.8 wt %, inclusive, for hardwood or bamboo, or in a range of 1.25-33.25 wt %, inclusive, for softwood. Lignin content before and after the partial delignification can be assessed using known techniques in the art, for example, Laboratory Analytical Procedure (LAP) TP-510-42618 for “Determination of Structural Carbohydrates and Lignin in Biomass,” Version Aug. 3, 2012, published by National Renewable Energy Laboratory (NREL), and ASTM E1758-01 (2020) for “Standard Test Method for Determination of Carbohydrates in Biomass by High Performance Liquid Chromatography,” published by ASTM International, both of which are incorporated herein by reference. In some embodiments, the partial delignification process can be, for example, as described in U.S. Publication No. 2020/0223091, published Jul. 16, 2020 and entitled “Strong and Tough Structural Wood Materials, and Methods for Fabricating and Use Thereof,” and U.S. Publication No. 2022/0412002, published Dec. 29, 2022 and entitled “Bamboo Structures, and Methods for Fabrication and Use Thereof,” the delignification and densification processes disclosed therein being incorporated herein by reference.

Lignin modification: In situ altering one or more properties of the original lignin content (e.g., prior to processing and/or at the time of harvesting the original plant material) in the plant or plant-based material, without removing at least some (e.g., most) of the lignin from and/or retaining at least some (e.g., most) of the lignin within the plant or plant-based material, or within an engineered structure formed therefrom. In some embodiments, the lignin content prior to and after the in situ modification can be substantially the same, for example, such that a lignin content of the modified plant or plant-based material (or an engineered structure formed therefrom) is at least 90% (e.g., removing no more than 10%, or no more than 1%, of the starting or native lignin content) of the starting or native lignin content. In some embodiments, the plant or plant-based material can be in situ modified (e.g., by chemical reaction with OH or other chemicals) to depolymerize lignin, with the depolymerized lignin being retained within the densified piece of plant or plant-based material (or an engineered structure formed therefrom). In some embodiments, the modified lignin has shorter macromolecular chains than that of starting lignin in the piece of plant or plant-based material (e.g., shorter than that of native lignin in the corresponding natural plant), and/or the modified lignin has more exposed functional groups on its surface as compared to the starting or native plant material. The lignin content before and after lignin modification can be assessed using known techniques in the art, for example, Laboratory Analytical Procedure (LAP) TP-510-42618 for “Determination of Structural Carbohydrates and Lignin in Biomass,” Version Aug. 3, 2012, published by National Renewable Energy Laboratory (NREL), ASTM E1758-01 (2020) for “Standard Test Method for Determination of Carbohydrates in Biomass by High Performance Liquid Chromatography,” published by ASTM International, and/or Technical Association of Pulp and Paper Industry (TAPPI), Standard T 222-om-83, “Standard Test Method for Acid-Insoluble Lignin in Wood,” all of which are incorporated herein by reference. In some embodiments, the lignin modification process can be, for example, as described in U.S. Publication No. 2024/0083067, published Mar. 14, 2024, and entitled “Waste-free Processing for Lignin Modification of Fibrous Plant Materials, and Lignin-modified Fibrous Plant Materials,” which lignin modification processes are incorporated herein by reference.

Densified Material: A plant or plant-based material that has been compressed to have at least one reduced cross-sectional dimension (e.g., thickness) and/or an increased density. In some embodiments, the dimension has been reduced by a factor of at least two. In some embodiments, the densified material can have a density greater than that of the native plant material and/or the starting plant or plant-based material, for example, at least 1 g/cm³, such as at least 1.1 g/cm³ or even at least 1.2 g/cm³ (e.g., 1.3-1.5 g/cm³). For example, the densified material can be formed as described in, but not limited to, U.S. Pat. No. 11,130,256, issued Sep. 28, 2021, and entitled “Strong and Tough Structural Wood Materials, and Methods for Fabricating and Use Thereof,” and U.S. Publication No. 2022/0412002, published Dec. 29, 2022, and entitled “Bamboo Structures, and Methods for Fabrication and Use Thereof,” each of which is incorporated herein by reference.

Fiber direction: A direction along which a plant grows from its roots or from a trunk thereof, with cellulose fibers forming cell walls of the plant being generally aligned along the fiber direction. In some embodiments, the fiber direction may be generally vertical and/or correspond to a direction of its water transpiration stream. This is in contrast to the radial direction, which extends from a center portion of the plant outward. In some embodiments, the fiber directions between plant or plant-based material pieces (e.g., strands) in a structure (e.g., assembly to be processed, densified piece, engineered structure, etc.) can be at least partially aligned, for example, with at least 80% of cellulose fibers therein having a direction of extension that is within 10° (e.g., ±5°) of each other.

Scrap Material: A structure or material that has been previously used and/or discarded, or otherwise resulted from fabrication of another structure or material, and that has been formed of, is based on, or otherwise comprises a plant or plant-based material. In some embodiments, scrap materials can include remnants of wood, bamboo, or other plant materials, such as but not limited to trimmings, offcuts, defective pieces, damaged pieces, unused leftover pieces, chips, sawdust, and pulp. Alternatively or additionally, in some embodiments, scrap material can include salvaged or recycled pieces of plant materials, such as but not limited to (i) defective pieces of wood, bamboo, or other plant materials; (ii) damaged pieces of wood, bamboo, or other plant materials; (iii) unused leftover pieces of wood, bamboo, or other plant materials; and (iv) wood, bamboo, or other plant material pieces from a demolished or dismantled structure. Alternatively or additionally, in some embodiments, scrap materials can include salvaged, recycled, or otherwise used or discarded pieces of plant-based materials (e.g., cardboard). Alternatively or additionally, in some embodiments, scrap materials can include agricultural waste, such as but not limited to cereal crop straws, sugarcane bagasse, corn stover, banana pseudostems, oilseed straws, and peels and/or cores of fruits and/or vegetables.

### Introduction

Disclosed herein are methods for transforming scrap materials (e.g., scrap plant materials and/or scrap plant-based materials) into engineered structures. In some embodiments, scrap materials can be cut into individual strands and arranged in an assembly (e.g., stack) with fiber directions thereof at least partially aligned (e.g., substantially aligned), subjected to a softening treatment, and then compressed to form a densified piece with enhanced mechanical properties. In some embodiments, the alignment of the fiber directions in the stack can be substantially maintained during the processing, for example, during the softening treatment and the compression. In some embodiments, the softening treatment can comprise a lignin compromising treatment (e.g., to partially remove lignin and/or modify lignin in the scrap plant or plant-based material). Alternatively or additionally, the softening treatment can comprise exposing the scrap material strands to water (e.g., by soaking in water, exposing to elevated humidity (e.g., 95% relative humidity (RH) and/or steam). In some embodiments, the densified piece can be incorporated into a laminated structure, for example, by combining with additional densified scrap material pieces, other plant or plant-based material pieces, and/or other materials (e.g., polymer, metal, etc.).

Unlike a bottom-up approach (e.g., using extracted nanocellulose) that completely destroys fiber alignment, one or more embodiments of the disclosed subject matter can substantially maintain the fiber alignment of the starting scrap material, reduce the amount of water used for fabrication, and/or offer a more energy efficient fabrication process. Alternatively or additionally, in some embodiments, the processing of the scrap material into one or more densified pieces can generate no or little material waste, for example, with substantially all (e.g., at least 90%) of the starting scrap material ending up in the final densified piece and/or engineered structure. Alternatively or additionally, in some embodiments, fabrication of the densified piece of scrap material, or an engineered structure comprising the densified piece, can generate no, or at least reduced, chemical waste (e.g., with chemicals used for lignin compromising being consumed by the processing).

Unlike conventional processes using virgin wood, one or more embodiments of the disclosed subject matter can provide engineered structures at lower cost (e.g., by employing scrap materials) and/or with dimensions larger than that capable with conventional lumber (e.g., without being restricted to the size of the grown tree). Alternatively or additionally, in some embodiments, the densified piece of scrap material, or an engineered structure comprising the densified piece, can exhibit enhanced mechanical properties. For example, in some embodiments, the densified scrap material can exhibit a tensile strength of at least 100 MPa (e.g., at least 200 MPa, or at least 300 MPa, or at least 400 MPa, for example, in a range of 600-800 MPa, inclusive). Alternatively or additionally, in some embodiments, the densified scrap material can exhibit a bending strength of at least 100 MPa (e.g., at least 150 MPa, or at least 200 MPa, or at least 250 MPa, for example, in a range of 100-300 MPa, inclusive). Alternatively or additionally, in some embodiments, the densified scrap material can exhibit a bending module of at least 5 GPa (e.g., at least 10 GPa, or at least 15 GPa, or at least 20 GPa, for example, in a range of 10-20 GPa, inclusive). Alternatively or additionally, in some embodiments, the densified scrap material can exhibit an improved compressive strength (e.g., load applied with respect to the fiber directions of the scrap material), with the compressive strength along the fiber direction (e.g., parallel to a longitudinal direction of the native plant) being increased by at least a factor of two (e.g., ≥3×) and/or the compressive strength perpendicular to the fiber direction (e.g., parallel to a radial or tangential direction of the native plant) being increased by at least a factor of ten (e.g., ≥20×). Alternatively or additionally, in some embodiments, the densified scrap material can exhibit a compressive strength of at least 100 MPa along the fiber direction and/or a compressive strength of at least 50 MPa (e.g., ≥100 MPa) perpendicular to the fiber direction.

In some embodiments, the lignin compromising treatment can swell the scrap material and can open the cell walls, which can allow, or at least improve the ability of, the scrap material to be densified in order to maximize, or at least improve, the packing density. Alternatively or additionally, in some embodiments, lignin released by the lignin compromising treatment, but otherwise retained within the assembly of scrap material strands, can be used as a binder (e.g., bonding agent) for the densified piece and/or a subsequently-formed engineered structure comprising the densified piece. Alternatively or additionally, in some embodiments, supplemental lignin (e.g., Kraft lignin) can be added to the assembly of scrap material strands, for example, for use as the binder for the densified piece and/or a subsequently-formed engineered structure comprising the densified piece. Alternatively or additionally, in some embodiments, a glue or other bonding agent (e.g., lignin-derived adhesive or other bio-based adhesive) can be added to the assembly of scrap material strands. Alternatively or additionally, in some embodiments, a filler (e.g., small volumes of biopolymer fillers, such as carboxymethyl cellulose (CMC)) can optionally be added to the assembly of scrap material strands prior to compression, for example, to seal local pores and/or to further enhance mechanical strength. Alternatively, in some embodiments, the densified piece of scrap material and/or laminated structures formed therefrom can utilize no external glue, binder, or bonding agent (e.g., instead using only released lignin retained in the assembly as a binder).

### Exemplary Methods for Fabricating Engineered Structures

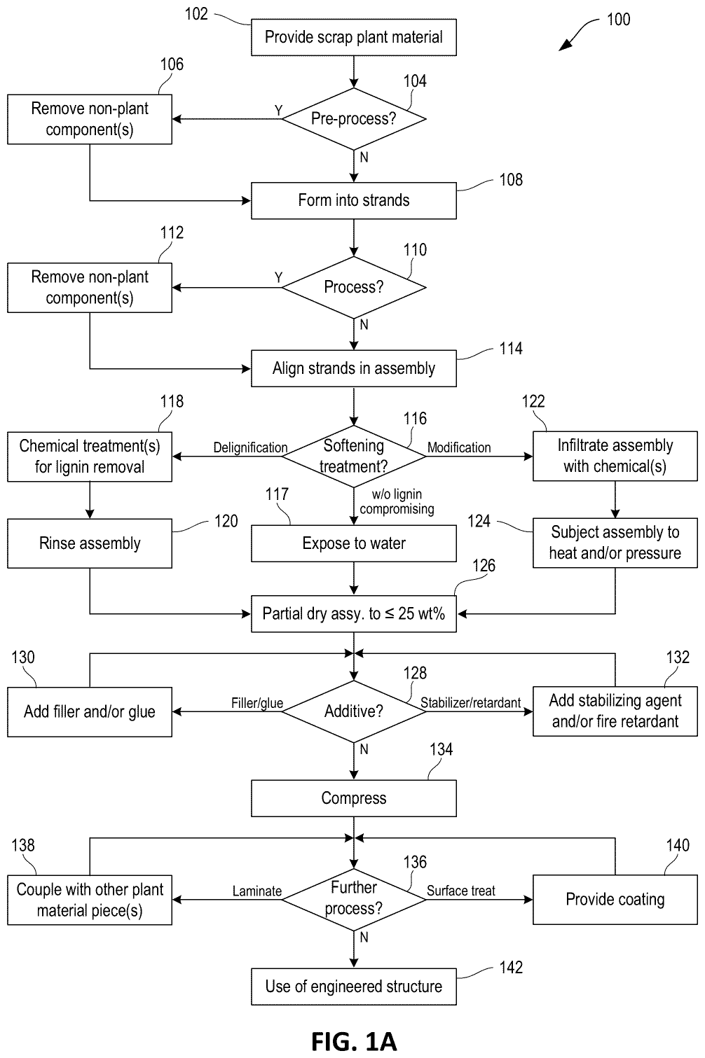

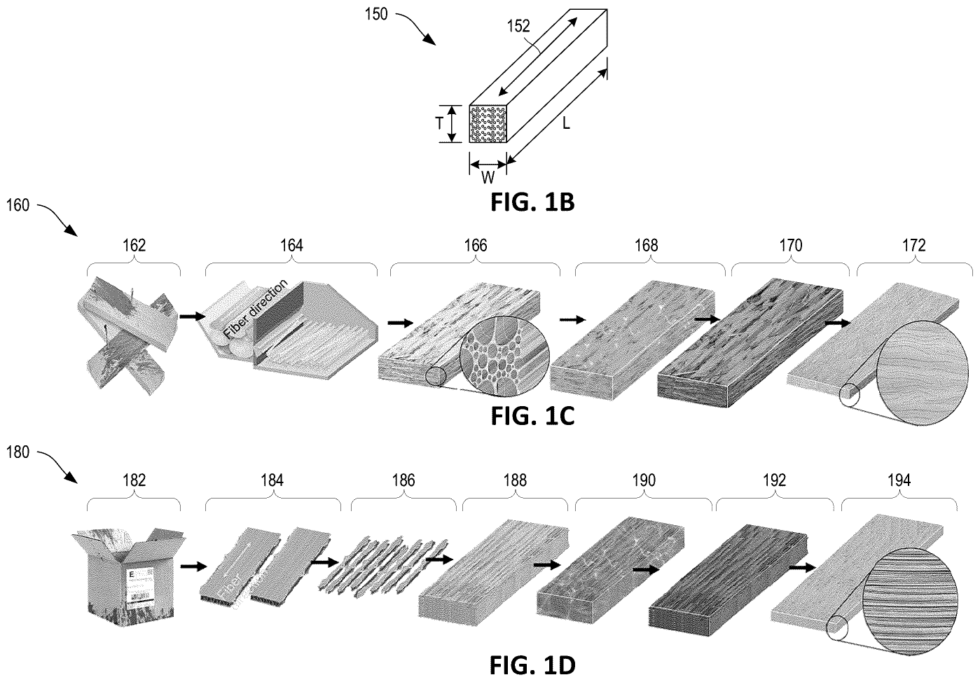

FIG. 1A shows aspects of a method 100 for fabricating an engineered structure from scrap material. The method 100 can initiate at process block 102, where one or more scrap materials can be obtained, selected, or otherwise provided. In some embodiments, process block 102 can include preparing the scrap material(s) for subsequent processing, for example, by cutting, shaping, or otherwise forming starting scrap material(s) for input into a stranding machine. Alternatively or additionally, process block 102 can include loading, arranging, or otherwise positioning the starting scrap material(s) for subsequent processing, for example, with fiber directions of individual scrap material piece(s) aligned with a blade and/or cutting direction of the stranding machine.

The method 100 can proceed to decision block 104, where it is determined if the scrap material(s) should be subjected to pre-processing to remove non-plant component(s). For example, for scrap material(s) lacking non-plant components and/or having a small amount of non-plant components (e.g., metal debris that can nevertheless be handled by the stranding machine with minimal impact to cutting operation and/or blade life) or if the subsequent processing (e.g., mechanical slicing and/or chemical treatment) is effective to remove the non-plant component(s) or at least where the presence of such components does not detrimentally affect the final densified piece and/or engineered structure, the method 100 can proceed directly from decision block 104 to process block 108.

However, if pre-processing is desired, the method 100 can proceed from decision block 104 to process block 106, where one or more non-plant components can be destroyed, separated from, or otherwise removed from the scrap material(s). Such non-plant components can include, but are not limited to, metals (e.g., nails, wires, pins, staples, etc.), applied materials (e.g., paper-based or plastic-based labels, tape, adhesives, etc.), polymeric impurities (e.g., inks, resins, stains, etc.), and coatings (e.g., paint, etc.). In some embodiments, for example, where the scrap material(s) has a high level of metal contaminant (e.g., wood pallet scraps), the pre-processing of process block 106 can comprise detecting the metal in the scrap material(s) (e.g., using a metal detector) and/or removing from the scrap material(s) using a magnet, a denailer, and/or an eddy current separator (ECS) (e.g., for non-ferrous debris, including wires).

After the pre-processing of process block 106, or if no pre-processing was desired at decision block 104, the method 100 can proceed to process block 108, where the scrap material(s) can be cut, sliced, shaped, or otherwise mechanically formed into individual strands. In some embodiments, for example, as shown in FIG. 1B, each individual strand 150 of scrap material can have a cross-sectional width, W or T, (e.g., in a plane perpendicular to a direction of its fiber direction 152) less than or equal to 5 mm, for example, less than or equal to 3.5 mm (e.g., in a range of 200-400 μm, inclusive). In some embodiments, the scrap material(s) is cut in a direction parallel to its fiber direction 152, such that the resulting strands each have a length, L, extending along the fiber direction 152 that is much greater than its width (e.g., a maximum dimension in the cross-section perpendicular to its length), for example, a length (e.g., L) at least 10 times greater than the width (e.g., W).

The method 100 can proceed to decision block 110, where it is determined if the scrap material strands should be subjected to processing to remove non-plant component(s). For example, if non-plant component(s) were retained in the scrap material(s) through process block 108 but the subsequent processing (e.g., chemical treatment) is effective to remove the non-plant component(s) or at least where the presence of such components does not detrimentally affect the final densified piece and/or engineered structure, the method 100 can proceed directly from decision block 110 to process block 114.

However, if mid-processing is desired, the method 100 can proceed from decision block 110 to process block 112, where one or more non-plant components can be destroyed, separated from, or otherwise removed from the scrap material strands. Such non-plant components can include, but are not limited to, metals (e.g., nails, wires, pins, staples, etc.), applied materials (e.g., paper-based or plastic-based labels, tape, adhesives, etc.), polymeric impurities (e.g., inks, resins, stains, etc.), and coatings (e.g., paint, etc.). In some embodiments, the processing of process block 112 can comprise detecting the metal in the scrap material strand(s) (e.g., using a metal detector) and/or removing from the scrap material strand(s) using a magnet and/or an ECS.

After the mid-processing of process block 112, or if no processing was desired at decision block 110, the method 100 can proceed to process block 114, where the scrap material strands can be arranged, positioned, or otherwise disposed in an assembly (e.g., three-dimensional assembly) with fiber directions of the individual strands being substantially aligned. In some embodiments, the assembly is and/or comprises a stack (e.g., a rectangular cuboid) of the scrap material strands; however, other three-dimensional shapes and constructions for the arranged scrap material strands are also possible according to one or more contemplated embodiments. For example, when the individual strands are formed by a stranding machine (e.g., where each strand is cut with respect to the fiber direction of its underlying scrap material), the output of strands from the stranding machine can be collected to form a stack, with fiber directions in the stack being substantially aligned.

The method 100 can proceed to decision block 116, where it is determined which softening treatment should be applied to the assembly of aligned scrap material strands. In some embodiments, the softening treatment can comprise one or more lignin-compromising chemical treatments, for example, for partial delignification (e.g., via process blocks 118-120, for example, using the delignification processes disclosed in either U.S. Publication No. 2020/0223091 or U.S. Publication No. 2022/0412002, incorporated by reference above) and/or in situ lignin modification (e.g., via process blocks 122-124, for example, using the lignin modification processes disclosed in U.S. Publication No. 2024/0083067, incorporated by reference above).

Alternatively, in some embodiments, the softening treatment does not involve lignin removal or modification. For example, when the scrap material is cardboard, which is made of unbleached chemical pulp fibers that are already substantially delignified, the method 100 can proceed from decision block 116 to process block 117, where the assembly of aligned scrap material strands are subjected to a cellulose softening treatment that does not necessarily target lignin (e.g., a non-lignin compromising treatment). For example, the softening treatment of process block 117 can include soaking in water, subjecting to water vapor (e.g., at an elevated relative humidity, such as ≥80% RH) or steam, or otherwise exposing to water, and/or subjecting to an elevated temperature (e.g., greater than ambient, such as 30-150° C., inclusive) for a predetermined period of time (e.g., at least 1 hour). Alternatively or additionally, in some embodiments, the softening treatment of process block 117 can include soaking, dipping, spraying, or otherwise exposing the scrap material strands to an alkaline solution (e.g., Na₂CO₃ at ambient temperature), for example, to enhance swelling of cellulose fibers therein and softening of the assembly prior to densification.

If partial delignification is instead desired at decision block 116, the method 100 can proceed to process block 118, where the assembly of aligned scrap material strands can be subjected to one or more chemical treatments to remove at least some lignin from the scrap material strands, for example, by exposing the assembly of aligned scrap material strands to one or more chemicals (e.g., in solution or as a gas phase) associated with the treatment. In some embodiments, each chemical treatment or at least one chemical treatment can be performed under vacuum, such that the chemical(s) associated with the treatment is encouraged to fully penetrate the cell walls and lumina of the scrap material strands. Alternatively, in some embodiments, the chemical treatment(s) can be performed under ambient pressure conditions or elevated pressure conditions (e.g., ˜ 6-8 bar). In some embodiments, each chemical treatment or at least one chemical treatment can be performed at any temperature between ambient (e.g., ˜23° C.) and an elevated temperature where a solution associated with the chemical treatment is boiling (e.g., ˜70-160° C.). In some embodiments, the solution is not agitated in order to minimize the amount of disruption to the cellulose-based microstructure of the scrap material strands and/or alignment thereof in the assembly.

In some embodiments, the time of exposure to the chemical(s) can be in a range of 0.1 to 96 hours, inclusive, for example, 1-12 hours, inclusive. The exposure time may be a function of the amount of lignin to be removed, type of scrap material, size of the scrap material strands and/or assembly, temperature of the chemical(s), pressure of the chemical treatment, and/or agitation. For example, smaller amounts of lignin removal, smaller scrap material strand sizes (e.g., strand width), smaller assembly sizes (e.g., height and/or width), higher chemical temperature, higher treatment pressure, and/or agitation may be associated with shorter exposure times, while larger amounts of lignin removal, larger scrap material strand sizes, larger assembly sizes, lower chemical temperature, lower treatment pressure, and/or no agitation may be associated with longer exposure times. The chemical treatment can continue (or can be repeated with subsequent chemical exposures) until a desired reduction in lignin content in the assembly of scrap material strands is achieved. In some embodiments, the lignin content can be reduced to between 5% (lignin content is 95% of the starting lignin content in the assembly, on a weight percent basis) and 95% (lignin content is 5% of the starting lignin content in the assembly, on a weight percent basis).

In some embodiments, the chemicals for the chemical treatment(s) can include sodium hydroxide (NaOH), lithium hydroxide (LiOH), potassium hydroxide (KOH), sodium sulfite (Na₂SO₃), sodium sulfide (Na₂S), NaₙS (where n is an integer), urea (CH₄N₂O), sodium bisulfite (NaHSO₃), sulfur dioxide (SO₂), anthraquinone (AQ) (C₁₄H₈O₂), methanol (CH₃OH), ethanol (C₂H₅OH), butanol (C₄H₉OH), formic acid (CH₂O₂), hydrogen peroxide (H₂O₂), acetic acid (CH₃COOH), butyric acid (C₄H₈O₂), peroxyformic acid (CH₂O₃), peroxyacetic acid (C₂H₄O₃), ammonia (NH₃), tosylic acid (p-TsOH), sodium hypochlorite (NaClO), sodium chlorite (NaClO₂), chlorine dioxide (ClO₂), chlorine (Cl₂), ozone (O₃), an enzyme (e.g., laccases), an organic solvent (e.g., ethanol, methanol, ethylene glycol, glycerol, acetic acid, formic acid, etc.), an ionic liquid, a deep eutectic solvent, or any combination of the above.

Examples of ionic liquids can include, but are not limited to, ethyl-3-methylimidazolium chloride, 1-ethyl-3-methylimidazolium acetate, 1-allyl-3-methylimidazolium chloride, 1-ethyl-3-methylimidazolium diethylphosphate, 1-butyl-3-methylimidazolium chloride, 1-butyl-3-methylimidazolium acetate, 1-butyl-3-methylimidazolium methylsulfate, pyridinium acetate, pyridinium formate, pyridinium propionate, 1-methylimidazolium acetate, pyrrolidinium acetate, γ-valerolactone, 1-butyl-3-methylimidazolium acetate, 1-butyl-3-methylimidazolium hydrogen sulphate, 1-ethyl-3-methylimidazolium alkylbenzenesulfonate, cholinium proline, cholinium phenylalanine, cholinium lysine, cholinium glycine, cholinium alanine, cholinium serine, cholinium threonine, cholinium methionine, 1-decyl-3-methylimidazolium methylsulfate, 1-benzyl-3-methylimidazolium chloride, 1-ethyl-3-methylimidazolium diethyl phosphate, and a metal chloride with lactic acid (e.g., ZnCl₂/lactic acid, AlCl₃/lactic acid, FeCl₃/lactic acid, CuCl₂/lactic acid). Examples of deep eutectic solvents can include, but are not limited to, choline chloride/lactic acid, choline chloride/glycerol, choline chloride/urea, choline chloride/malic acid, choline chloride/triethanolamine, and potassium carbonate/ethylene glycol.

Exemplary combinations of chemicals for the chemical treatment of process block 118 can include, but are not limited to, NaOH+O₂, NaOH+Na₂SO₃, NaOH+Na₂S, NaOH+urea, NaHSO₃+SO₂+H₂O, NaHSO₃+Na₂SO₃, NaOH+Na₂SO₃, NaOH+AQ, NaOH+Na₂S+AQ, NaHSO₃+SO₂+H₂O+AQ, NaOH+Na₂SO₃+AQ, NaHSO₃+AQ, NaHSO₃+Na₂SO₃+AQ, Na₂SO₃+AQ, NaOH+Na₂S+NaₙS (where n is an integer), Na₂SO₃+NaOH+CH₃OH+AQ, C₂H₅OH+NaOH, CH₃OH+HCOOH, NH₃+H₂O, and NaClO₂+acetic acid. For example, the chemical treatment can comprise a solution of ≤2 wt % NaOH and Na₂SO₃ (e.g., formed by adding H₂SO₃ acid to NaOH).

After partial delignification, the method 100 can proceed from process block 118 to process block 120, where the assembly of aligned scrap material strands can optionally be rinsed, for example, to remove residual chemicals and/or particulate(s) resulting from the chemical treatment(s). For example, the assembly of partially-delignified scrap material strands can be partially or fully immersed in one or more rinsing solutions. The rinsing solution can be a solvent, such as but not limited to, de-ionized (DI) water, alcohol (e.g., ethanol, methanol, isopropanol, etc.), or any combination thereof. For example, the rinsing solution can be formed of equal volumes of water and ethanol. In some embodiments, the rinsing can be performed without agitation, for example, to avoid disruption of the scrap material microstructure and/or maintain alignment of fiber directions in the assembly. In some embodiments, the rinsing may be repeated multiple times (e.g., at least 3 times) using a fresh rinsing solution for each iteration and/or until a substantially neutral pH is measured for the assembly of scrap material stands.

If in situ lignin modification is instead desired at decision block 116, the method 100 can instead proceed to process block 122, where the assembly of aligned scrap material strands can be infiltrated with one or more chemicals (e.g., in solution or gas phase) to modify lignin therein. In some embodiments, the infiltration can comprise soaking the assembly of aligned scrap material strands in a solution under vacuum. For example, to perform in situ lignin modification, the assembly of scrap material strands can be infiltrated with one or more chemical solutions to modify lignin therein. In some embodiments, the concentration of the chemicals for lignin modification can be at a concentration of 5 wt % or less, for example, in a range of 1-4 wt %, inclusive. In some embodiments, the chemical infiltration can be performed without heating, e.g., at room temperature (20-30° C., such as ˜22-23° C.). In some embodiments, the chemical solution is not agitated in order to avoid disruption to the cellulose-based microstructure of the scrap material and/or alignment of the scrap material strands in the assembly. In some embodiments, the chemical treatment of process block 122 used to modify the lignin (or the chemical treatment of process block 118 used to remove lignin) can also be effective to remove, or at least enhance removal, of polymeric contaminants in the scrap material. For example, the chemical treatment for lignin modification (e.g., using Na₂CO₃) can decompose various wood paints, inks, and stains while enabling the cellulose fibers to de-bond from the adhesives during the chemical reactions.

In some embodiments, at least one of the chemicals for in situ lignin modification has OH-ions or is otherwise capable of producing OH ions in solution. In some embodiments, one, some, or all of the chemicals for in situ lignin modification can be alkaline in solution. In some embodiments, the chemicals for in situ lignin modification can include, but are not limited to, p-toluenesulfonic acid, Na₂CO₃, oxygen, ozone, NaOH, LiOH, KOH, Na₂O, an enzyme (e.g., laccases), an organic solvent (e.g., ethanol, methanol, ethylene glycol, glycerol, acetic acid, formic acid, etc.), an ionic liquid, a deep eutectic solvent, or any combination thereof. Examples of ionic liquids can include, but are not limited to, ethyl-3-methylimidazolium chloride, 1-ethyl-3-methylimidazolium acetate, 1-allyl-3-methylimidazolium chloride, 1-ethyl-3-methylimidazolium diethylphosphate, 1-butyl-3-methylimidazolium chloride, 1-butyl-3-methylimidazolium acetate, 1-butyl-3-methylimidazolium methylsulfate, pyridinium acetate, pyridinium formate, pyridinium propionate, 1-methylimidazolium acetate, pyrrolidinium acetate, γ-valerolactone, 1-butyl-3-methylimidazolium acetate, 1-butyl-3-methylimidazolium hydrogen sulphate, 1-ethyl-3-methylimidazolium alkylbenzenesulfonate, cholinium proline, cholinium phenylalanine, cholinium lysine, cholinium glycine, cholinium alanine, cholinium serine, cholinium threonine, cholinium methionine, 1-decyl-3-methylimidazolium methylsulfate, 1-benzyl-3-methylimidazolium chloride, 1-ethyl-3-methylimidazolium diethyl phosphate, and a metal chloride with lactic acid (e.g., ZnCl₂/lactic acid, AlCl₃/lactic acid, FeCl₃/lactic acid, CuCl₂/lactic acid). Examples of deep eutectic solvents can include, but are not limited to, choline chloride/lactic acid, choline chloride/glycerol, choline chloride/urea, choline chloride/malic acid, choline chloride/triethanolamine, and potassium carbonate/ethylene glycol.

Exemplary combinations of chemicals for the in situ lignin modification of process block 122 can include, but are not limited to, p-toluenesulfonic acid, NaOH+O₂, NaOH+Na₂SO₃/Na₂SO₄, NaOH+Na₂S, NaHSO₃+SO₂+H₂O, NaHSO₃+Na₂SO₃, NaOH+Na₂SO₃, NaOH/NaH₂O₃+AQ, NaOH/Na₂S+AQ, NaOH+Na₂SO₃+AQ, Na₂SO₃+NaOH+CH₃OH+AQ, NaHSO₃+SO₂+AQ, NaOH+Na₂Sx, where AQ is Anthraquinone, any of the foregoing with NaOH replaced by LiOH or KOH, or any combination of the foregoing. In some embodiments, to reduce greenhouse gases (GHGs), Na₂CO₃ can be used in place of NaOH. In some embodiments, the reaction can be conducted at 150° C. for 1 hour in aqueous solution. Alternatively or additionally, oxygen can be used for the in situ lignin modification, and the reaction can be conducted in gas phase at 100° C. for 1 hour.

For example, in some embodiments, the assembly of aligned scrap material strands can be immersed in a chemical solution (e.g., 2-5% NaOH) in a container. The container can then be placed in a vacuum box and subjected to vacuum (e.g., 0.1 MPa). In this way, the air in the assembly can be drawn out and form a negative pressure. When the vacuum pump is turned off, the negative pressure inside the assembly can suck the solution into the assembly through the natural channels in the scrap material (e.g., lumina defined by longitudinal cells) and/or interstices between aligned strands. The process can be repeated more than once (e.g., 3 times), such that the channels inside the scrap material strands can be filled with the chemical solution (e.g., about 2 hours). After this process, the moisture content can increase (e.g., from <15 wt % for the starting stack to 50 wt % or greater for the infiltrated stack).

The method 100 can proceed to process block 124, where the chemical-infiltrated assembly of aligned scrap material strands can be subjected to an elevated temperature, for example, greater than 80° C. (e.g., 100-180° C., such as 120-160° C.) and/or elevated pressure, so as to activate the lignin modification and thereby result in an assembly of softened scrap material strands (e.g., softened as compared to the starting scrap material). In some embodiments, the heating of process block 124 can be achieved via steam heating, for example, via steam generated in an enclosed reactor (e.g., pressure reactor), via a steam flow in a flow-through reactor, and/or via steam from a superheated steam generator. Alternatively or additionally, in some embodiments, the heating of process block 124 can be achieved via dry heating, for example, via conduction and/or radiation of heat energy from one or more heating elements without separate use of steam. Other mechanisms of heating are also possible according to one or more embodiments of the disclosed subject matter.

In some embodiments, the assembly of infiltrated scrap plant material strands can be subjected to the elevated temperature for a first time period of, for example, 1-10 hours (e.g., depending on the size of the scrap material strands and/or assembly thereof, with larger sizes utilizing longer heating times). In some embodiments, after the first time period, any steam generated by heating of the assembly can be released, for example, by opening a pressure release (e.g., relief valve) of the reactor. For example, in some embodiments, the pressure release can be effective to remove ˜50% of moisture in the assembly. For example, in some embodiments, the assembly of now softened scrap material strands can have a moisture content in a range of 30-50 wt %, inclusive.

In some embodiments, the infiltration and heating of the scrap material strands can be effective to modify the lignin therein, for example, by OH reacting with the phenolic hydroxyl group in lignin and breaking down the linking bonds of lignin macromolecules, which shortens the lignin macromolecular chains and softens the scrap material strands. In addition, OH can also degrade hemicellulose in the scrap material by peeling reaction and can produce some acidic degradation products that can react with the alkaline solution (e.g., NaOH) and form neutral salts. In some embodiments, no black liquor is observed during the lignin modification process, and the degradation products from hemicellulose and lignin can be immobilized within the channels of the softened scrap material strands. Since the chemicals are consumed in the process, the assembly of scrap material strands can exhibit a neutral pH.

After the assembly of scrap material strands has been softened by any of process blocks 117-124, the method 100 can proceed to process block 126, where the assembly of aligned scrap material strands can be partially dried, for example, to have a moisture content less than or equal to 25 wt %. For example, the assembly can be dried via evaporation (e.g., at ambient temperature or at an elevated temperature). In some embodiments, the partial drying of process block 126 can be effective to remove free water from the assembly of scrap material strands, such that all, or at least most, of the remaining water in the assembly is bound water (e.g., the stack having a moisture content of ˜23 wt %).

The method 100 can proceed to decision block 128, where it is determined if the partially-dried assembly of aligned scrap material strands should include one or more additives (e.g., filler(s), glue(s), stabilizing agent(s), and/or fire retardant(s). In some embodiments, the lignin in the assembly (e.g., modified by lignin modification of process blocks 122-124 or released by the partial delignification of process block 118) can be incorporated into the final densified piece. Without being bound by any particular theory, the lignin released by the lignin-compromising treatment can fill spaces between strands in the assembly and may function as a filler and/or bonding agent. Thus, in some embodiments, the method 100 may proceed to process block 134 without any separately provided additive.

Alternatively or additionally, in some embodiments, if a filler and/or glue is desired, for example, to supplement any bonding between strands provided by the retained lignin or provide bonding between strands, the method 100 can proceed from decision block 128 to process block 130, where the filler and/or glue can be added to the assembly of aligned scrap material strands. For example, the glue can include, but is not limited to, externally-derived lignin (e.g., Kraft lignin) or other biopolymer, epoxy, polyurethane adhesives, two-component polyurethane adhesives, polyvinyl acetate-isocyanate adhesives and resorcinol formaldehyde resin adhesives, and/or phenolic resin. Without being bound by any particular theory, the added lignin (e.g., alone or together with the retained lignin from the lignin-compromising treatment) can fill spaces between strands in the assembly and may act as a filler and/or bonding agent. For example, the filler can comprise derivatives or synthesized large molecule polysaccharides that are rich in polar (e.g., organic acid) groups, such as carboxyl and hydroxyl groups. In some embodiments, the polysaccharide can comprise starch, chitin, chitosan, cellulose, sodium carboxymethyl cellulose (CMC), methyl cellulose, ethyl hydroxyethyl cellulose, hydroxyethyl cellulose, and/or hydroxypropyl methylcellulose. Further examples of fillers can be found in International Publication No. WO-2024/129827, published Jun. 20, 2024, and entitled “Adhesive-Free Engineered Plant Materials, and Methods for Fabrication Thereof,” which is incorporated by reference herein in its entirety.

Alternatively or additionally, in some embodiments, if a water stabilizing agent or fire retardant is desired, the method 100 can proceed from decision block 128 to process block 132, where the stabilizing agent (or precursor(s) thereof) and/or fire retardant (or precursor thereof) can be added to the stack of aligned scrap material strands. For example, chemicals such as aluminum hydroxide (Al(OH)₃) and/or aluminum diethyl phosphinate can be incorporated into the stack of scrap material strands to enhance the water stability and/or fire resistance. Other fire retardants are also possible according to one or more contemplated embodiments, such as but not limited to antimony trioxide, magnesium hydroxide, aluminum hydroxide, borate, tributyl phosphate, tris (2-ethylhexyl) phosphate, tris(2-chloroethyl) phosphate, tricresyl phosphate, and triphenyl phosphate. In some embodiments, aspects of providing the stabilizing agent and/or fire retardant in process block 132 can be combined with, or occur at the same time as, the compression of process block 134, for example, by introducing one or more precursors into the stack of aligned scrap material strands. For example, the stabilizing agent (e.g., to reduce water swelling) may be similar to that described in International Publication No. WO-2024/220910, published Oct. 24, 2024, and entitled “Plant Materials with Improved Water Stability, and Methods for Fabrication Thereof,” which is incorporated by reference herein in its entirety.

After the provision of additives in process block 130 and/or process block 132, or if no additives were desired at decision block 128, the method 100 can proceed to process block 134, where the stack of softened, aligned scrap material strands can be compressed, for example, to form a densified piece. In some embodiments, the compression of process block 134 can employ mechanical pressing (e.g., with assistance of remaining bound water) in a direction crossing (e.g., perpendicular) to the aligned fiber directions. In some embodiments, the compressing of process block 134 can be such that a thickness of the stack of the scrap material strands is reduced (e.g., to no more than 50% of an original thickness prior to the compressing), a density of the scrap material strands is increased from a first density (e.g., ≤0.5 g/cm³) to a second density (e.g., ≥1.0 g/cm³), and/or a mechanical strength is increased (e.g., tensile strength, bending strength, bending modulus, compressive strength, etc.). In some embodiments, the compressing of process block 134 can be sufficient to collapse the lumina in the microstructure of the scrap material strands, such that facing portions of cell walls defining the lumina come into contact with each other within the strand, such that hydrogen bonds are formed between the cellulose fibers of the contacting portions within each strand, and/or such that interstices between adjacent strands within the assembly are eliminated (or at least reduced).

In some embodiments, the compressing of process block 134 can be at a pressure of at least 0.5 MPa (e.g., 0.5-10 MPa, such as about 5 MPa) and/or a temperature of at least 20° C. (e.g., in a range of 20-120° C., inclusive, such as 80-120° C., inclusive). In some embodiments, the compressing of process block 134 can include more than one pressing stage, for example, with a first stage occurring at a different pressure and/or temperature (e.g., lower) than that of a subsequent second stage (e.g., higher pressure). In some embodiments, aspects of the softening treatment (e.g., any of process blocks 117-124) and/or partial drying (e.g., process block 126) can be combined with, or occur at the same time as, the compressing of process block 126, for example, the exposure of the stack of aligned scrap material strands to an elevated temperature.

The method 100 can proceed to decision block 136, where it is determined if the densified piece should be subjected to further processing. In some embodiments, the method 100 can proceed from decision block 136 to process block 138, where the densified piece of scrap material can be combined, joined, or otherwise coupled with one or more other plant material pieces (e.g., densified), for example, to form a laminated structure. For example, multiple densified pieces of scrap material can be arranged (e.g., with fiber directions substantially aligned) and coupled together (e.g., via a glue, bonding agent, and/or filler) to form another assembly. Alternatively or additionally, the assembly of multiple densified pieces can be further pressed, for example, to yield a densified block or board. In some embodiments, the further pressing can maintain an alignment of the fiber directions within each constituent piece of scrap material, as well as between the constituent pieces in the densified block or board.

Alternatively or additionally, the method 100 can proceed to process block 140, where a surface treatment can be applied to the densified piece of scrap material. In some embodiments, the surface treatment of process block 140 can enhance the water stability and/or weatherability of the densified piece. For example, the surface treatment of process block 140 can include, but is not limited to, coating with tung oil, marine-grade epoxy, polyurethane, varnish, lacquer, and/or polymerized linseed oil.

The method 100 can then proceed to process block 142, where the densified scrap material piece(s) can be used (e.g., as a building material, structural material, or in any other application where enhanced strength may be advantageous), or otherwise adapted for such use (e.g., by machining, cutting, forming, coupling, etc.). In some embodiments, the adaptation for use can include combining (e.g., assembling, joining, or otherwise coupling) the scrap material piece(s) with one or more other plant or plant-based material piece(s) (e.g., native plant or densified plant; same species or different species), for example, in a manner similar to that described in International Publication No. WO-2024/004160, published Feb. 29, 2024, and entitled “Strength-enhanced Engineered Structural Materials, and Methods for Fabrication and Use Thereof,” and/or International Publication No. WO-2024/129827, published Jun. 20, 2024, and entitled “Adhesive-free Engineered Plant Materials, and Methods for Fabrication Thereof,” each of which is incorporated by reference herein. Alternatively or additionally, the densified scrap material piece(s) can be combined with one or more non-plant materials (e.g., metal, plastic, ceramic, composite, etc.) to form a heterogenous composite structure.

Although blocks 102-142 of method 100 have been described as being performed once, in some embodiments, multiple repetitions of a particular process block may be employed before proceeding to the next decision block or process block. In addition, although blocks 102-142 of method 100 have been separately illustrated and described, in some embodiments, process blocks may be combined and performed together (simultaneously or sequentially). Moreover, although FIG. 1A illustrates a particular order for blocks 102-142, embodiments of the disclosed subject matter are not limited thereto. Indeed, in certain embodiments, the blocks may occur in a different order than illustrated or simultaneously with other blocks. In some embodiments, a method can include steps or other aspects not specifically illustrated in FIG. 1A. Alternatively or additionally, in some embodiments, a method may comprise only some of blocks 102-142 of FIG. 1A.

FIG. 1C illustrates aspects of an exemplary process 160 for making an engineered structure from scrap wood. Scrap wood 162 can be provided at cutting stage 164 into a slicing machine, which cuts the scrap wood into thin strands, which can be arranged with fiber directions aligned in a stack 166. In some embodiments, the starting scrap material can be large scrap wood (e.g., logs, boards, and other pieces). The starting scrap wood 162 can be carefully aligned into the slicing machine, for example, such that the slicing direction (e.g., via rotation slitting) is substantially parallel to a fiber direction of the scrap wood. The thin strands or sheets resulting from the cutting stage 164 can have a thickness (e.g., a size in cross-section) in a range of 1/10-inch (˜2.5 mm) to ⅛-inch (˜3.2 mm), inclusive. Other thicknesses for the strands are also possible, for example, an average thickness less than 2 mm (e.g., about 200 μm). The stack of aligned strands can then be subjected to a softening treatment 168, followed by partial drying 170 (e.g., air or ambient drying) and compression to form a densified wood piece 172.

FIG. 1D illustrates aspects of an exemplary process 180 for making an engineered structure from scrap cardboard 182. The scrap cardboard can be initially processed 184 (cut, disassembled, etc.) into separate pieces, for example, based on fiber direction. The cut cardboard pieces can then be further cut (e.g., via a slicing machine) into thin strands 186, which can be arranged with fiber directions aligned in a stack 188. The thin cardboard strands 186 can have a thickness (e.g., a size in cross-section) in a range of 1/10-inch (˜2.5 mm) to ⅛-inch (˜3.2 mm), inclusive. Other thicknesses for the strands are also possible, for example, an average thickness less than 2 mm (e.g., about 200 μm). The stack of aligned strands can then be subjected to a softening treatment 190, followed by partial drying 192 (e.g., air or ambient drying) and compression to form a densified piece 194. Alternatively, the cardboard strands can be first soaked in water, followed by aligned stacking, either concurrent with or prior to a lignin-comprising chemical treatment.

### Laminated Structure Examples

In some embodiments, a densified scrap material piece can be incorporated into a laminated structure, for example, by coupling together with one or more other plant or plant-based material pieces (e.g., densified or otherwise). In some embodiments, the arrangement of the pieces within the laminated structure can be based at least in part on the mechanical properties (e.g., tensile strength, density, etc.) of constituent pieces and/or the characteristics (e.g., scrap material size, scrap material source, etc.) of the scrap material used to form the constituent pieces. For example, the processing of scrap material feedstock prior to softening treatment can include feedstock grading, stranding, and/or layered aligned piling. Engineered wood products made with highly aligned wood strands can be used to carry tensile and bending loads in structural applications due to their highly anisotropic physical and mechanical performance. To maximize strength, high-grade strands (e.g., longer fibers, higher alignment, and/or higher density) can be placed on the outer layer while low-grade strands (e.g., shorter fiber, lower alignment, and/or lower density) can be placed in the center. In some embodiments, feedstocks can be graded based on their fiber qualities, and the strands of different grades can be strategically layered in the stacking to maximize, or at least increase, performance.

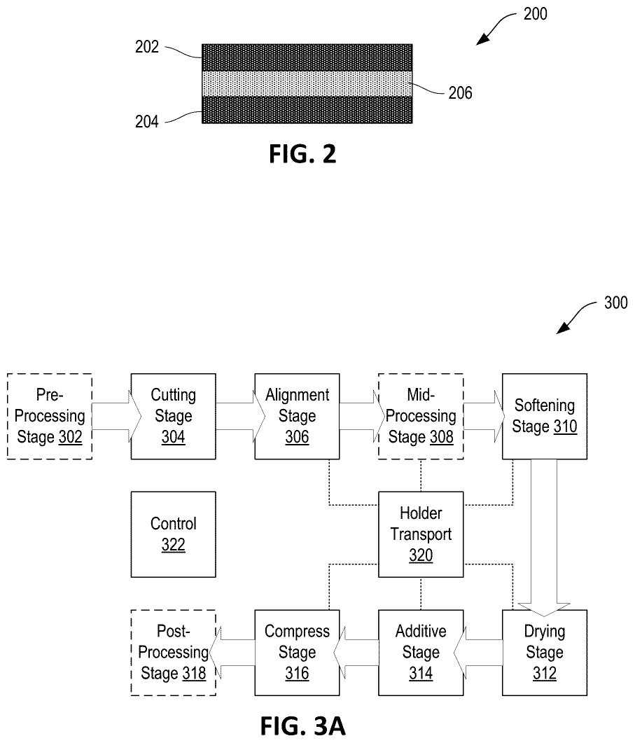

For example, FIG. 2 illustrates a laminated structure 200 comprising a first layer 202, a second layer 204, and a third layer 206 disposed between the first and second layers. In some embodiments, the first layer 202 may be externally-facing and/or subjected to relatively high stress, and the first layer 202 can include a densified piece formed from higher quality scrap material (e.g., scrap wood), formed from scrap material strands having longer lengths and/or smaller widths, and/or has a lignin content >5 wt %. Alternatively or additionally, the second layer 204 may be an internal layer and/or subject to relatively low stress, and the second layer 204 can include a densified piece formed from lower quality scrap material (e.g., scrap cardboard), formed from scrap material strands having shorter lengths and/or larger widths, and/or has a lignin content ≤5 wt %. In some embodiments, the third layer 204 may be externally-facing and/or subjected to relatively high stress, and can include a densified piece similar to the first layer 202. Alternatively, the third layer 204 may be non-externally-facing and/or subject to relatively low stress, and can include a densified piece similar to the second layer 206. Additional or fewer layers are also possible for the laminated structure 200 according to one or more embodiments of the disclosed subject matter.

### Scrap Material Processing System Examples

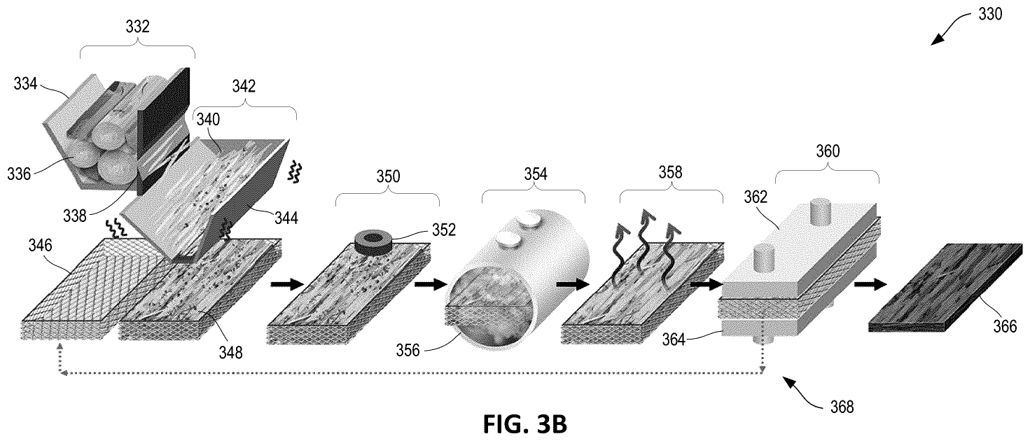

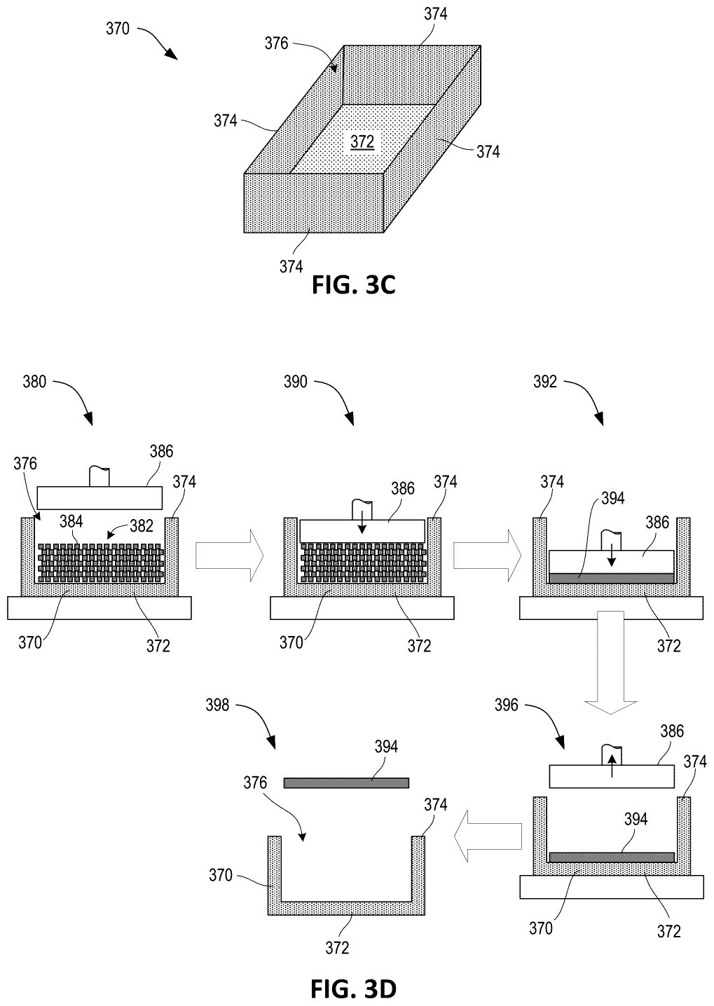

FIG. 3A illustrates aspects of a generalized system 300 for processing of scrap materials. In the illustrated example, the system 300 includes an optional pre-processing stage 302, a cutting stage 304, an alignment stage 306, an optional mid-processing stage 308, a softening stage 310, a drying stage 312, an optional additive stage 314, a compression or densification stage 316, an optional postprocessing stage 318, a holder transport mechanism 320, and a control system 322. However, in some embodiments, a system for processing of scrap materials can include fewer or additional stages, or some of the illustrated stages can be combined together. The control system 322 can be operatively coupled to one, some, or all of the illustrated stages and can be configured to control operations thereof.

The pre-processing stage 302 can remove one or more non-plant components from an input feedstock of scrap plant or plant-based materials. For example, the pre-processing stage 302 can include a magnet, denailer, and/or eddy current separator to remove metal debris from the scrap material feedstock. Alternatively or additionally, the pre-processing stage 302 can use heat and/or chemicals to dissolve, degrade, or otherwise remove applied materials, polymeric impurities, and/or coatings from the scrap material feedstock. In some embodiments, the pre-processed scrap material feedstock can be provided from the pre-processing stage 302 to the cutting stage 304, which can use one or more blades to slice the feedstock into individual strands. In some embodiments, the feedstock can be cut along a direction parallel to its fiber direction to form the individual strands, with each strand output from the cutting stage 304 having a cross-sectional width, for example, less than or equal to 5 mm.

The individual scrap material strands from the cutting stage 304 can be disposed into a an assembly (e.g., stack) in and/or by the alignment stage 306. In some embodiments, the strands within the assembly can have fiber directions substantially aligned. In some embodiments, the assembly of strands can be disposed within a holder (e.g., a tray or basket) for transport between and/or processing within the subsequent stages, for example, while maintaining the aligned fiber directions of the strands within the assembly. In some embodiments, a holder transport mechanism 320 can include one or more robotic units, conveyor mechanisms, motors, and/or other transport or assembly line devices for transporting the holder between the different stages. Alternatively, in some embodiments, different holders may be provided for one, some, or each stage and/or a holder may be omitted for certain stages (e.g., compression stage), with the alignment of the fiber directions still being maintained between the different stages.

The assembly of aligned scrap material strands can be provided to mid-processing stage 308, which can remove one or more non-plant components from the assembly of scrap material strands, for example, any contaminants or debris not previously removed by the pre-processing stage 302. For example, the mid-processing stage 308 can include a magnet, denailer, and/or eddy current separator to remove metal debris from the stack of scrap material strands. Alternatively or additionally, the mid-processing stage 308 can use heat and/or chemicals to dissolve, degrade, or otherwise remove applied materials, polymeric impurities, and/or coatings from the scrap material feedstock.

In some embodiments, the processed assembly of aligned scrap material strands can be provided from the mid-processing stage 302 to softening stage 310, where the assembly can be subjected to one or more chemical treatments (e.g., to partially remove lignin from and/or modify lignin within the scrap material strands) and/or exposed to water. In some embodiments, the treatment(s) and/or water exposure of the softening stage can be performed with the assembly in the holder, for example, to retain the alignment of the fiber directions of the strands.

In some embodiments, the softened assembly of aligned scrap material strands can be provided to drying stage 312, where the assembly can be partially dried, for example, to remove free water. In some embodiments, the drying can be effective to reduce the water content of the assembly of scrap material strands to less than 25 wt % (e.g., about 20 wt %). For example, the drying can be via ambient drying (e.g., evaporation in air) or any of conductive, convective, and/or radiative heating and/or drying processes, such as but not limited to an air-drying process, a vacuum-assisted drying process, an oven drying process, a freeze-drying process, a critical point drying process, a microwave drying process, or any combination of the foregoing. In some embodiments, the drying of the drying stage can be performed with the assembly in the holder, for example, to retain the alignment of the fiber directions of the strands.

In some embodiments, the partially-dried assembly of aligned scrap material strands can be provided to additive stage 314, where one or more additives can be provided to the assembly for incorporation into the eventual densified piece. For example, the one or more additives can include a filler (e.g., polysaccharide), a glue, a water stabilizing agent, and/or a fire retardant. In some embodiments, the additive can be provided while the assembly is in the holder, for example, to retain the alignment of the fiber directions of the strands.

In some embodiments, the partially-dried assembly of aligned scrap material strands with additive(s) can be provided to compression stage 316, where the assembly of aligned scrap material strands can be compressed to form a densified scrap material piece. In some embodiments, the compression stage 316 can include a mechanical press with one or more movable platens that apply pressure to opposing surfaces of the assembly of aligned scrap material strands, for example, in a direction substantially perpendicular to, or at least crossing, the aligned fiber directions of the scrap material strands. In some embodiments, the compressing of the assembly by the compression stage can be performed while the assembly is in the holder, for example, to retain the alignment of the fiber directions of the strands.

In some embodiments, the densified scrap material piece can be provided from the compression stage 316 to post-processing stage 318, where one or more surface treatments can be applied to the densified scrap material piece. For example, the surface treatments can include coating with tung oil, marine-grade epoxy, polyurethane, varnish, lacquer, and/or polymerized linseed oil. Alternatively or additionally, in some embodiments, post-processing stage 318 can combine the densified scrap material piece with other plant or plant-based material pieces, for example, to form a laminated structure. In some embodiments, since the alignment of the fiber directions of the strands has been set by the densification, the densified scrap material piece can be removed from the holder for provision to the post-processing stage 318. In some embodiments, the now empty holder can be returned to the beginning stages (e.g., alignment stage 306) for reuse.

FIG. 3B illustrates additional aspects of a scrap material processing system 330, for example, capable of handling large-scale inputs (e.g., ≥10 kg). In the illustrated example, scrap material 336 (e.g., scrap wood) is loaded into a feed hopper 334 of a cutting stage 332, where a blade 338 of a slicing machine cuts the scrap material along its respective fiber direction into thin, long strands 340. The cut scrap material strands 340 fall into a piling hopper 344 of alignment stage 342, which funnels the strands (e.g., through a long, narrow slit) into a stack 348 with fiber directions of the individual strands being substantially aligned. The stack 348 can be collected in a movable holder 346 (e.g., porous basket) that can move the stack between different stages while substantially maintaining the alignment of the fiber directions. In some embodiments, the piling hopper 344 can be integrated with a linear shaker, for example, to help distribute the individual strands in the holder 346.

The holder 346 with stack 348 therein can be transported to processing stage 350, where one or more magnets 352 are used to remove metal debris, and then to a softening stage 354. In some embodiments, the softening stage 354 can include a treatment vessel 356 (e.g., reactor) in which the holder 346 with stack 348 can be subjected to one or more chemical treatments (e.g., for partial delignification and/or in situ lignin modification). After softening, the holder with stack therein can be transported to a drying stage 358, where free water within the stack of scrap material strands can be removed via evaporation or other drying. The partially-dried stack can optionally be mixed (e.g., sprayed) with additives and then subject to densification via top platen 362 and bottom platen 364 of a hot press in densification stage 360. In some embodiments, the stack can be pressed in the densification stage 360 while it is in the holder 346, for example, such that the top platen enters into contact with the stack via an open end of the holder. After densification, the now densified scrap material piece 366 can be removed from the holder for subsequent uses and/or further processing, while the holder 346 can be returned to the alignment stage 342 via return loop 368 for reuse.

In some embodiments, the holder can be porous (e.g., a porous basket) to the treatment(s) of the softening stage to be performed on the assembly of scrap material strands without having to remove the assembly from the holder. Alternatively or additionally, the holder can include at least one open end (e.g., a top end) to allow the strands to be arranged within the holder to form the assembly, to allow processing to be performed on the assembly (e.g., in processing stage 350) without removing the assembly from the holder, and/or to allow the assembly to be compressed (e.g., in densification stage 360) without removing the stack from the holder. For example, FIG. 3C illustrates an exemplary configuration of a porous holder 370 having a bottom wall 372, a plurality of side walls 374 extending from the bottom wall 372, and an open top 376 opposite the bottom wall 372 and formed by edges of the side walls 374.

During a densification operation as shown in FIG. 3D, the bottom wall 372 of the holder 370 can be disposed on a bottom platen (e.g., stationary or movable) of a mechanical press, and the holder 370 can have a stack 382 of aligned scrap material strands 384 disposed therein. A top platen 386 of the mechanical press can move through the open top 376 of the holder 370 during approach phase 380 and into contact with an upper surface of the stack 382 during contact phase 390. Further movement of the top platen 386 toward the bottom platen (or vice versa) can apply a pressure (e.g., at least 0.5 MPa) to the stack that compresses and densifies the stack during compression phase 392, thereby forming densified piece 394. The top platen 386 and/or the bottom platen can move away from each other during retraction phase 396 to allow the densified piece 394 to be unloaded from the holder 370 during unloading phase 398. In some embodiments, the holder 370 and the top platen 386 are sized and shaped such that the top platen 386 does not contact the side walls 374 of the holder 370 during the densification operation.

### Computer Implementation Examples

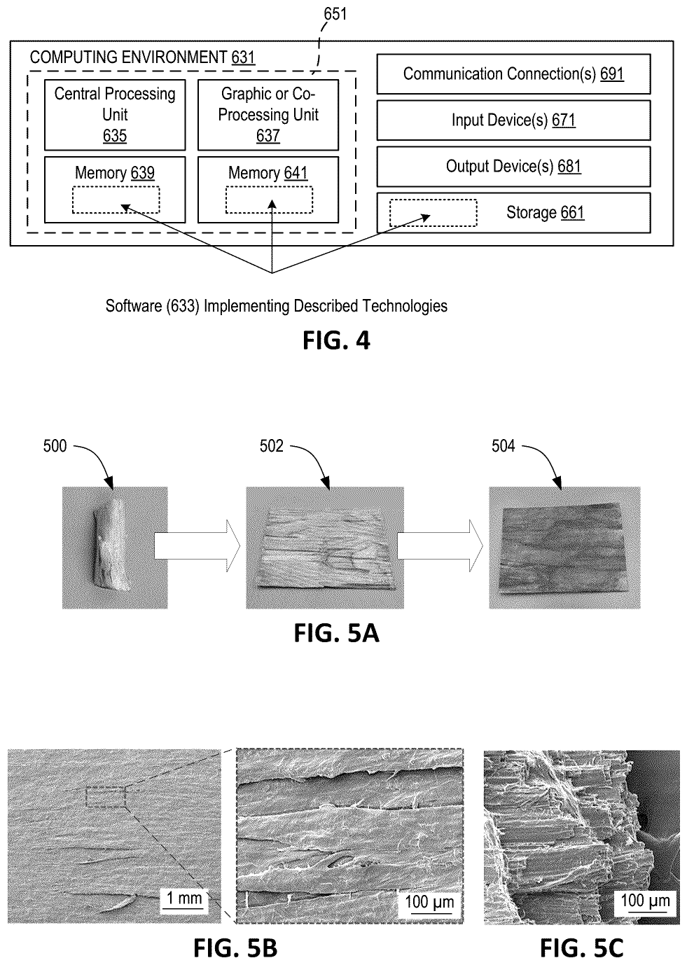

FIG. 4 depicts a generalized example of a suitable computing environment 631 in which the described innovations may be implemented, such as but not limited to control system 322, a controller of scrap material processing system 330 or component thereof, and/or method 100. The computing environment 631 is not intended to suggest any limitation as to scope of use or functionality, as the innovations may be implemented in diverse general-purpose or special-purpose computing systems. For example, the computing environment 631 can be any of a variety of computing devices (e.g., desktop computer, laptop computer, server computer, tablet computer, etc.).

With reference to FIG. 4, the computing environment 631 includes one or more processing units 635, 637 and memory 639, 641. In FIG. 4, this basic configuration 651 is included within a dashed line. The processing units 635, 637 execute computer-executable instructions. A processing unit can be a central processing unit (CPU), processor in an application-specific integrated circuit (ASIC), or any other type of processor (e.g., hardware processors, graphics processing units (GPUs), virtual processors, etc.). In a multi-processing system, multiple processing units execute computer-executable instructions to increase processing power. For example, FIG. 4 shows a central processing unit 635 as well as a graphics processing unit or co-processing unit 637. The tangible memory 639, 641 may be volatile memory (e.g., registers, cache, RAM), non-volatile memory (e.g., ROM, EEPROM, flash memory, etc.), or some combination of the two, accessible by the processing unit(s). The memory 639, 641 stores software 633 implementing one or more innovations described herein, in the form of computer-executable instructions suitable for execution by the processing unit(s).

A computing system may have additional features. For example, the computing environment 631 includes storage 661, one or more input devices 671, one or more output devices 681, and one or more communication connections 691. An interconnection mechanism (not shown) such as a bus, controller, or network interconnects the components of the computing environment 631. Typically, operating system software (not shown) provides an operating environment for other software executing in the computing environment 631, and coordinates activities of the components of the computing environment 631.

The tangible storage 661 may be removable or non-removable, and includes magnetic disks, magnetic tapes or cassettes, CD-ROMs, DVDs, or any other medium which can be used to store information in a non-transitory way, and which can be accessed within the computing environment 631. The storage 661 can store instructions for the software 633 implementing one or more innovations described herein.

The input device(s) 671 may be a touch input device such as a keyboard, mouse, pen, or trackball, a voice input device, a scanning device, or another device that provides input to the computing environment 631. The output device(s) 681 may be a display, printer, speaker, CD-writer, or another device that provides output from computing environment 631.

The communication connection(s) 691 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, radio-frequency (RF), or another carrier.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or any other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java™, Python®, and/or any other suitable computer language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means. In any of the above-described examples and embodiments, provision of a request (e.g., data request), indication (e.g., data signal), instruction (e.g., control signal), or any other communication between systems, components, devices, etc. can be by generation and transmission of an appropriate electrical signal by wired or wireless connections.

### Fabricated Examples and Experimental Results

### Example 1: Densified Scrap Wood

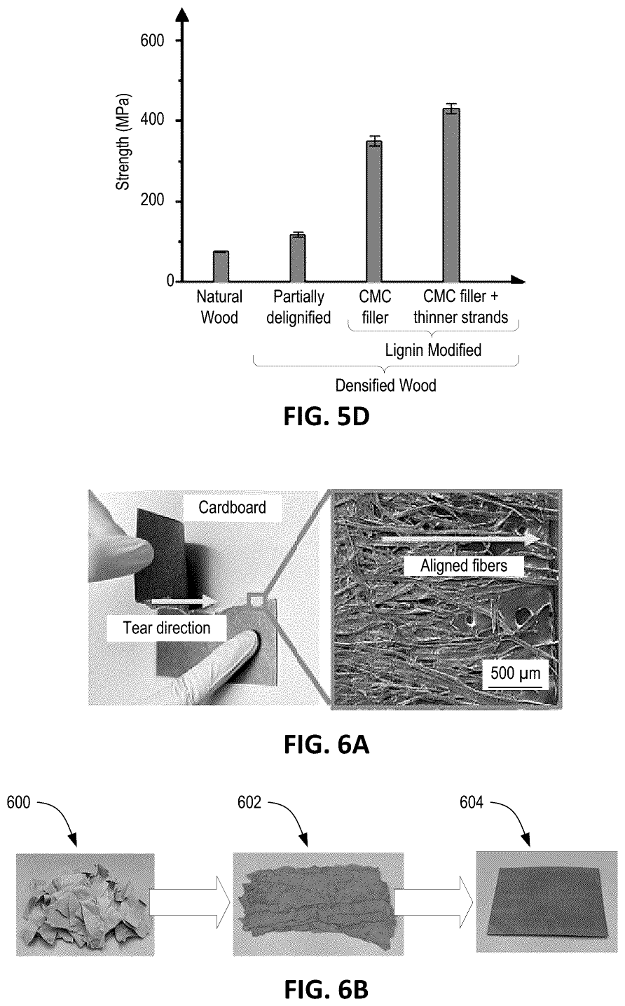

A piece 500 of scrap wood was cut into strands, each having a size of about 80 mm×20 mm×0.3 mm. 200 grams of the wood strands were soaked in 5% sodium hydroxide (NaOH) solution at room temperature under 5 bar pressure for 4 hours. The chemical-filled wood strands were then added into a digester (without solutions) and heated for 30 minutes at 170° C. The softened wood strands were then dried in air for 3 hours to reduce the moisture content thereof to ˜20%. The pre-dried wood strands were then coated with CMC. The stack 502 of aligned wood strands and CMC was then compressed under a pressure of 5 MPa and a temperature of 120° C. to form a densified board 504, as shown in FIG. 5A. The densified board (also referred to herein as densified block or densified piece) retains a fiber alignment similar to virgin wood, as shown in FIGS. 5B-5C. As shown in FIG. 5D, the resulting densified board with CMC exhibits an enhanced tensile strength as compared to natural wood or densified wood without filler. By cutting the scrap wood into even smaller strands, the resulting densified wood can exhibit even higher strength, e.g., ˜430 MPa.

### Example 2: Densified Scrap Cardboard

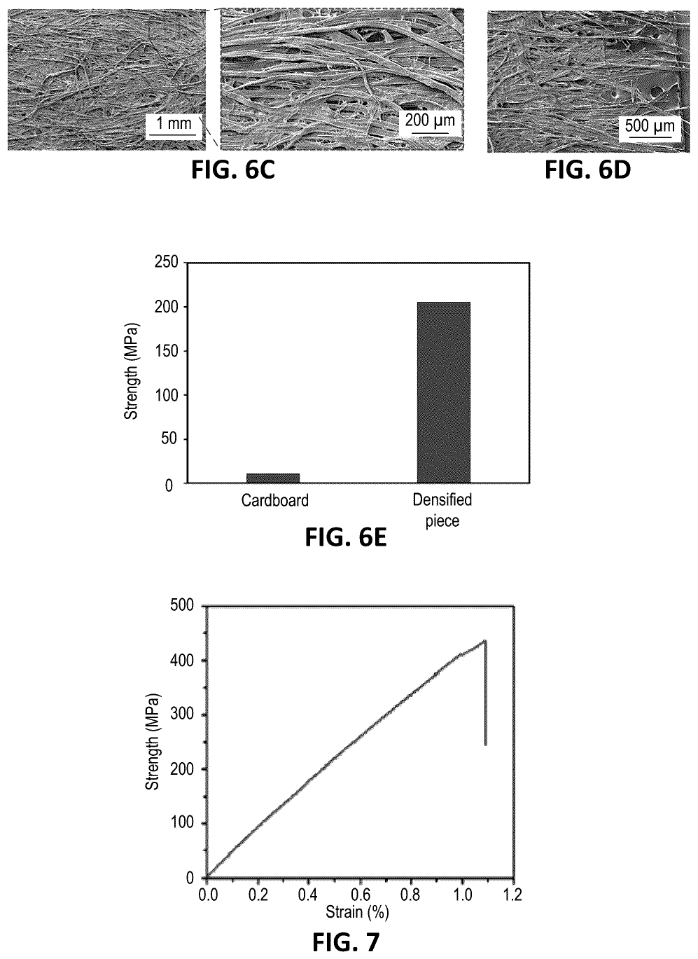

The cellulose fibers can be partially aligned within the cardboard during its original fabrication (e.g., the papermaking process), and this fiber direction can be identified by a simple mechanical tear test (e.g., the direction with a weaker tear strength corresponding to the aligned fiber direction), as shown in FIG. 6A. The scrap cardboard was aligned and subjected to mechanical slicing into thin strips 600 (e.g., ˜3.2 mm in width). The strips (e.g., ˜200 g) were then stacked together, subjected to chemical treatment by soaking in 1% NaOH solution at room temperature for 1 hour, and then dried in air for 1.5 hours to reduce the moisture content thereof to ˜20%, thereby forming a lignin-compromised stack 602. The pre-dried cardboard strands were then coated with CMC, and the stack of cardboard strands and CMC was then compressed under a pressure of 5 MPa and a temperature of 120° C. to form a densified board 604, as shown in FIG. 6B. The resulting densified board can exhibit anisotropy, as shown in FIGS. 6C-6D, and an enhanced tensile strength of about 205 MPa, as shown in FIG. 6E.

### Example 3: Densified Scrap Cardboard

Similar to the processing of Example 2 above, strips of scrap cardboard were stacked together with fiber directions aligned. In contrast to Example 2, the strips were subjected to chemical treatment by soaking in a solution of Na₂CO₃ at room temperature for 1 hour, and then dried in air for 1.5 hours to reduce the moisture content thereof to ˜20%, thereby forming a lignin-compromised stack. The pre-dried cardboard strands were then coated with CMC, and the stack of cardboard strands and CMC was then compressed under a pressure of 5 MPa and a temperature of 120° C. to form a densified board. The performance of the resulting densified board subjected to a tensile test is shown in FIG. 7.

### Comparative Example

Conventional parallel strand lumber (PSL) has wood strands oriented in parallel fashion and bonded together using adhesives. The strands used in PSL are thin veneer elements with a thickness of about 2.5 mm ( 1/10 inch) to 3.2 mm (⅛ inch), a width of 12.7 mm (½ inch), and lengths of up to 8 feet. PSL employs an adhesive comprised of phenol formaldehyde mixed with wax. Most of the current PSL utilizes Douglas fir or southern pine. By adjusting density, the manufactured tensile strength of PSL can be tuned to fall within the range of approximately ˜100 MPa. In contrast, lignin from the scrap wood/cardboard, derived from an in-situ chemical treatment process, can be used as a bonding agent without the introduction of any additional glue or filler. After densification, the thickness of the starting strands (˜ 1/10 to ⅛ inch | 2.5-3.2 mm) is significantly reduced (e.g., ˜ 1/50 to 1/40 inch | 0.5-0.64 mm).

TABLE 1
Comparison between PSL and disclosed
densified board from scrap material.

| | | Parallel-Strand | Densified |
|---|---|---|---|
| | | Lumber | Board |
| Similarities | Partial fiber | Yes | Yes |
| | alignment | | |
| Differences | Strand thickness | ⅛ to 1/10 | 1/50 to 1/40 |
| | (inches) | | |
| | Chemical treatment | No | Yes |
| | to soften wood | | |
| | Glue | phenol- | lignin from |
| | | formaldehyde | scrap material |
| | Density (g/cm³) | ~0.7 | ~1.3 |
| | Tensile strength | 100 | ≥400 |
| | (MPa) | | |
| | Compressive | 30 | ~200-300 |
| | strength (MPa) | | |
| | Shear strength | 4 | ~30 |
| | (MPa) | | |
| | Stiffness | 0.002 | ~0.3 |
| | (GPa) | | |

### Materials Testing Methodology

Dimensional stability (e.g., along-grain length change from 10% relative humidity (RH) to 90% RH at 30° C.) was evaluated with an environmental chamber (e.g., Humidity Chamber HCP, sold by Memmert GmbH of Schwabach, Germany). Strengths (e.g., specific strength, tensile strength, compressive strength, shear strength, etc.) as well as stiffness were measured by a universal testing machine (e.g., an INSTRON 5565 universal tester—a screw-driven machine with a load capacity of 3000 kN). For tensile strength testing, the samples were prepared (e.g., machined) and/or tested in accordance with existing industry standards, for example, ASTM D638-14, “Standard Test Method for Tensile Properties of Plastic,” updated on Jul. 21, 2022, which is incorporated by reference herein. For compressive strength testing, the sample were prepared (e.g., machined) and/or tested in accordance with existing industry standards, for example, ASTM-D3501-05a (2018), “Standard Test Methods for Wood-Based Structural Panels in Compression,” updated on Nov. 20, 2018, which in incorporated by reference herein.

The stiffness testing included performing a three-point bending test to failure using the INSTRON 5565 universal tester, where curves of load versus displacement were recorded for each specimen tested and the curves for flexural stress versus displacement were calculated. For the stiffness testing, the samples were prepared (e.g., machined) and/or tested in accordance with existing industry standards, for example, ASTM D1037-12 (2020), “Standard Test Methods for Evaluating Properties of Wood-Base Fiber and Particle Panel Materials,” updated on Nov. 12, 2020, which is incorporated by reference herein. The length of each sample was about 24 times the thickness thereof, and the test span was about 120 mm.

### CONCLUSION

Any of the features illustrated or described herein, for example, with respect to FIGS. 1A-7, can be combined with any other feature illustrated or described herein, for example, with respect to FIGS. 1A-7, to provide systems, materials, structures, methods, examples, and embodiments not otherwise illustrated or specifically described herein. All features described herein are independent of one another and, except where structurally impossible, can be used in combination with any other feature described herein. In view of the many possible aspects to which the principles of the disclosed technology may be applied, it should be recognized that the illustrated features are only examples and should not be taken as limiting the scope of the disclosed technology. Rather, the scope is defined by the following claims. Applicants therefore claim all that comes within the scope and spirit of these claims.

1. A system for processing scrap material, the scrap material comprising scrap plant or plant-based material, the system comprising:
a cutting stage comprising one or more blades, the cutting stage being constructed to cut an input feedstock of the scrap material into individual strands, each strand having a fiber direction along which cellulose fibers therein are substantially aligned;
one or more holders;
an alignment stage constructed to dispose the strands of scrap material from the cutting stage within at least one of the one or more holders such that the fiber directions of the disposed strands are substantially aligned, thereby forming an assembly of scrap material within the at least one holder;
a lignin compromising stage comprising one or more treatment vessels, the lignin comprising stage being constructed to receive the at least one holder with the assembly therein and to chemically treat the scrap material strands so as to modify a property of lignin within and/or partially remove the lignin from the strands forming the assembly; and
a densification stage comprising a mechanical press, the densification stage being constructed to receive the at least one holder with the chemically-treated assembly therein and to compress the chemically-treated assembly so as to form a densified piece of scrap material,
wherein the one or more holders are constructed to move the assembly of scrap material between and within the alignment stage, the lignin compromising stage, and the densification stage, while substantially maintaining alignment of the fiber directions of the strands forming the assembly.

2. The system of claim 1, further comprising:
one or more additive stages between the lignin compromising stage and the densification stage, each additive stage being constructed to provide an additive to the assembly prior to densification,
wherein the additive is incorporated into the densified piece, and
the additive comprises a polysaccharide filler, a glue, a water stabilizing agent, and/or a fire retardant.

3. The system of claim 1, wherein the one or more holders comprise a porous basket having:
a bottom wall;
two or more side walls extending from the bottom wall; and
an open top opposite the bottom wall and formed at least in part by edges of the side walls.

4. The system of claim 3, wherein the porous basket is sized and shaped such that a platen of the mechanical press moves into contact with the chemically-treated assembly via the open top and such that the platen compresses the chemically-treated assembly without contacting the two or more side walls of the porous basket.

5. The system of claim 1, further comprising:
(a) a processing stage between the cutting stage and the lignin compromising stage, the processing stage being constructed to remove one or more non-plant components from the strands of scrap material, wherein the one or more non-plant components comprise a metal, and the processing stage comprises one or more magnets for removing the metal; or
(b) a pre-processing stage prior to the cutting stage, the pre-processing stage being constructed to remove one or more non-plant components from the input feedstock prior to cutting, wherein the one or more non-plant components comprise a metal, a label, a coating, or any combination of the foregoing; or
(c) both (a) and (b).

6. The system of claim 1, further comprising:
a drying stage between the lignin compromising stage and the densification stage, the drying stage being constructed to receive the at least one holder with the chemically-treated assembly therein and to reduce a moisture content of the chemically-treated assembly to less than or equal to 25 wt %.

7. The system of claim 1, further comprising:
a post-processing stage after the densification stage, the post-processing stage being constructed to apply a surface treatment or coating to one or more external surfaces of the densified piece of scrap material.

8. The system of claim 1, further comprising:
a control system operatively coupled to the cutting stage, the alignment stage, the lignin compromising stage, and the densification stage,
wherein the control system comprises one or more processors and computer-readable storage media storing instructions that, when executed by the one or more processors, cause the control system to control the cutting stage, the alignment stage, the lignin compromising stage, and the densification stage to process the scrap material into the densified piece.

9. A method for processing scrap material, the scrap material comprising scrap plant or plant-based material, the method comprising:
providing an assembly of individual strands of the scrap material, each strand having a fiber direction along which cellulose fibers therein are substantially aligned, the fiber directions of the individual strands within the assembly being substantially aligned;
subjecting the assembly of individual strands of scrap material to one or more chemical treatments so as to modify a property of lignin within and/or partially remove the lignin from the strands of scrap material forming the assembly, while maintaining alignment of the fiber directions of the strands forming the assembly; and
compressing the chemically-treated assembly so as to form a densified piece of scrap material.

10. The method of claim 9, wherein the subjecting to one or more chemical treatments and the compressing are performed with the assembly disposed in a holder that maintains the alignment of the fiber directions of the strands forming the assembly.

11. (canceled)

12. The method of claim 10, wherein:
the holder comprises a porous basket having a bottom wall, two or more side walls extending from the bottom wall, and an open top opposite the bottom wall and formed at least in part by edges of the side walls, and
the compressing comprises moving a platen of a mechanical press into contact with the chemically-treated assembly via the open top and applying pressure via the platen to the chemically-treated assembly without contacting the two or more side walls of the porous basket.

13. The method of claim 9, wherein the providing comprises cutting an input feedstock of the scrap material to form the individual strands.

14. The method of claim 9, further comprising:
after the subjecting and prior to the compressing, providing an additive to the assembly,
wherein the additive is incorporated into the densified piece by the compressing, and
the additive comprises a polysaccharide filler, a glue, a water stabilizing agent, and/or a fire retardant.

15. The method of claim 14, wherein the polysaccharide filler comprises starch, chitin, chitosan, cellulose, carboxymethyl cellulose, methyl cellulose, ethyl hydroxyethyl cellulose, hydroxyethyl cellulose, hydroxypropyl methylcellulose, or any combination of the foregoing.

16. The method of claim 14, wherein the glue comprises Kraft lignin, epoxy, polyurethane adhesives, two-component polyurethane adhesives, polyvinyl acetate-isocyanate adhesives, resorcinol formaldehyde resin adhesives, phenolic resin, or any combination of the foregoing.

17-18. (canceled)

19. The method of claim 9, further comprising:
prior to the compressing, removing one or more non-plant components from the scrap material, and
the non-plant components comprise a metal, a label, a coating, or any combination of the foregoing.

20. The method of claim 9, further comprising, after the subjecting to one or more chemical treatments and prior to the compressing, drying the chemically-treated assembly to have a moisture content less than or equal to 25 wt %.

21-22. (canceled)

23. An engineered structure formed from scrap material, the scrap material comprising scrap plant or plant-based material, the engineered structure comprising:
one or more laminated structures, each laminated structure comprising a plurality of plant or plant-based material pieces forming at least two layers, each plant or plant-based material piece being coupled to an adjacent plant or plant-based material piece, at least one of the plant or plant-based material pieces having a density of at least 1 g/cm³,
wherein the plant or plant-based material pieces in at least one of the at least two layers are formed from the scrap plant material, and
the plant or plant-based material pieces in a first layer of the at least two layers have mechanical strengths greater than those of the plant or plant-based material pieces in a second layer of the at least two layers.

24. The engineered structure of claim 23, wherein:
(a) the plant or plant-based material pieces in the first layer are formed from native plant material or scrap material having a first size, and the plant or plant-based material pieces in the second layer are formed from scrap material having a second size less than the first size or from cardboard as the scrap material; or
(b) the plant material pieces in the first layer have a first lignin content, and the plant material pieces in the second layer have a second lignin content less than the first lignin content; or
(c) both (a) and (b).

25. (canceled)

26. The engineered structure of claim 23, wherein, for each laminated structure:
the first layer is arranged at an externally facing portion of the laminated structure and/or in a region of the laminated structure subjected to a first stress; and
the second layer is arranged at a non-externally facing portion of the laminated structure and/or in a region of the laminated structure subjected to a second stress less than the first stress.
